(19) United States
(12) Patent Application Publication
(10) Pub. No.: US 2014/0150250 A1
(43) Pub. Date: Jun. 5, 2014

(54) MULTI-TOOL FOR CHRISTMAS LIGHT BULBS

(71) Applicant: Raymond Kolasa, Farmington Hills, MI (US)

(72) Inventor: Raymond Kolasa, Farmington Hills, MI (US)

(21) Appl. No.: 13/691,915

(22) Filed: Dec. 3, 2012

(51) Int. Cl. B25F 1/00

(52) U.S. Cl. CPC B25F 1/00
USPC 29/650

(57) ABSTRACT

A multi-tool for use with light bulbs has a slot at one end insertable into the space between a light bulb holder and a light bulb socket. Downward force exerted on the opposite end of the tool creates a leverage force to separate the light bulb holder from the socket. The tool is a one-piece member having a U-shaped slot on one end. The multi-tool has a peripheral edge with the thickness configured for insertion into a straight slot of a screw to facilitate movement of the screw. Small radius corners between adjacent portions of the peripheral edge of the tool body are configured for insertion into the cross slots of a Phillips head screw to facilitate movement of a Phillips head screw.

### CROSS REFERENCE TO CO-PENDING APPLICATION

### Background of the Invention

The present invention relates to an improved Christmas mini light bulb removal tool.

### SUMMARY

A U-shape slot is formed in one end of thin rigid body and is insertable between a small opening between the light bulb holder and the upper edge of the bulb socket.

Any of the flat side or end edges of the rigid body can be inserted into the slot of a flat head slotted screw to thread or unthread the screw. The small radius ends of the multi-tool may also be inserted into the cross slots of a Phillips head screw to thread and unthread a Phillips head screw.

### BRIEF DESCRIPTION OF THE DRAWINGS

The description herein makes reference to the accompanying drawings:

FIG. 1 is a plan view of the present multi-tool light bulb remover;

FIG. 2 is a side elevational view of the multi-tool light bulb remover shown in FIG. 1;

FIG. 3 is a perspective view showing the use of the multi-tool with a flat slotted screw; and

FIG. 4 is a perspective view showing the use of the multi-tool with a Phillips head screw.

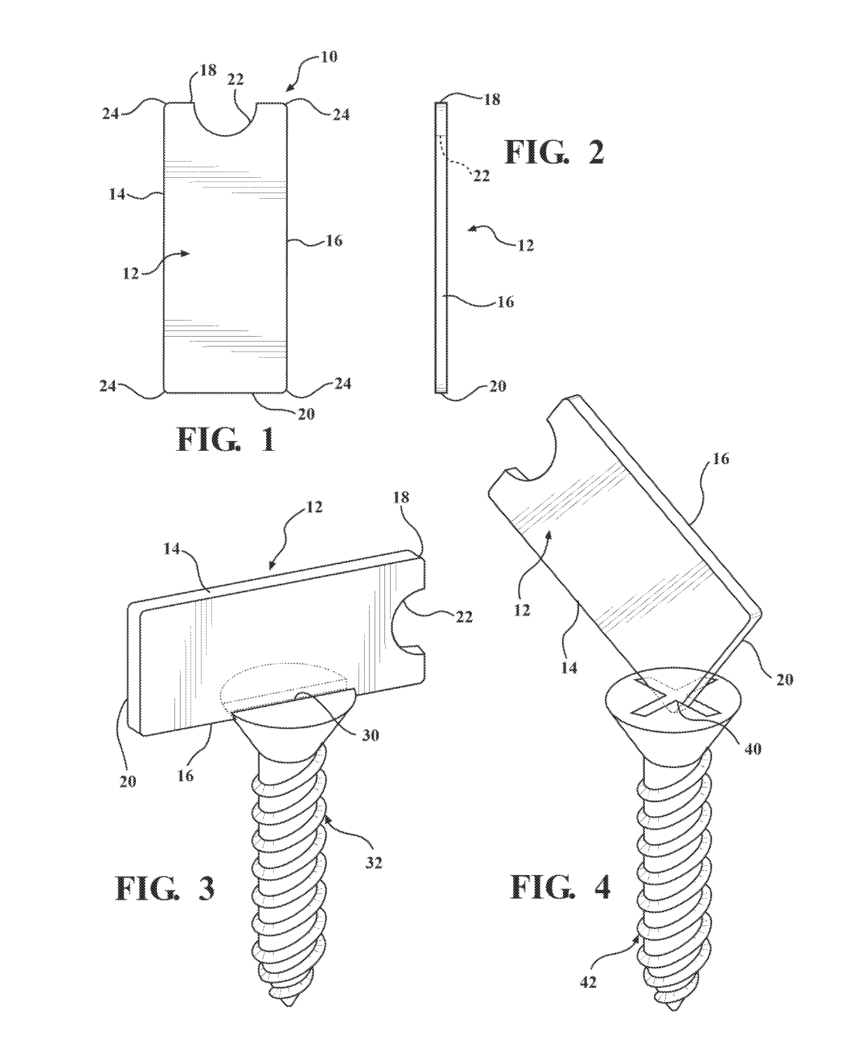

### DETAILED DESCRIPTION

The present invention is a Christmas mini light bulb remover or tool used to separate light bulbs or light bulb holders from the base or sockets in multiple mini light bulb strings.

The tool 10 is in the form of a generally flat, planar body 12 formed of a relatively rigid material. For example, the body 12 may have a thickness of about 0.020 to about 0.025 inches, a length of about 1.5 inches, and width of about 0.5 inches. The body 12, for example, has a rectangular shape formed of two opposed sides 14, 16 and two opposed ends 18, 20.

One of the ends 18 is formed with an inward extending U-shaped slot 22. The slot 22, for example, can have a width of between about 0.280 and about 0.282 inches, a length of about 0.25 inches and terminates in an inner 0.25 inch radius.

The slot 22 can be inserted between the small opening between the base of a light bulb holder and the upper edge of the socket in which the light bulb is mounted. A downward force on the end 20 of the tool 10 directed toward the bottom of the light string socket exerts an oppositely directed counter force which unseats and separates the light bulb holder from the light string socket.

The small thickness of the body 12, which may be between 0.020 to about 0.025 inches, enables any of the side edges 14 and 16 or any of the two opposed ends 18 and 20, including the narrow end portions bonding the end of the slot 22 in the end 18 of the body 12, may be inserted into the linear slot 30 of a flat, straight slotted screw 32. This enables the multi-tool 12 to be used to thread and unthread a straight slotted screw 32.

In addition, the small radius edges 24 at each corner of the body 12 are small enough to be inserted into the cross slot 40 of a Phillips head screw 42. The enables the multi-tool 12 to also be used to thread and unthread a Phillips head screw 42.

What is claimed is:

1. A multi-tool for use with light bulbs comprising:
a one piece body having a peripheral edge with a thickness;
a slot extending inward from the periphery of the tool and adapted to be placed in a leveraging position between a light bulb holder and light bulb socket; and
the thickness of the body configured for insertion into a slot of a screw to facilitate movement of the screw.

2. The multi-tool of claim 1 wherein:
the slot is a U-shaped slot.

3. The multi-tool of claim 1 wherein:
the thickness of the body configured for insertion into a slot of a straight slotted screw to facilitate movement of the screw.

4. The multi-tool of claim 1 wherein:
the body has radius corners between adjacent portions of the peripheral edge, the radius corners configured for insertion into a cross slot of a Phillips' head screw to facilitate movement of the Phillips' head screw.
